(19) United States
(12) Patent Application Publication
(10) Pub. No.: US 2021/0108501 A1
(43) Pub. Date: Apr. 15, 2021

(54) Critical Spare Part Identification Process for Mobile Offshore Drilling Units

(71) Applicant: Seadrill Americas Inc., Houston, TX (US)

(72) Inventor: Raphael SUAREZ, Katy, TX (US)

(21) Appl. No.: 17/069,046

(22) Filed: Oct. 13, 2020

Related U.S. Application Data
(60) Provisional application No. 62/914,782, filed on Oct. 14, 2019.

(51) Int. Cl. E21B 44/00; E21B 19/14; E21B 19/20; G05B 23/02; G06K 9/62

(52) U.S. Cl. CPC E21B 44/00; E21B 19/14; G06K 9/6277; G05B 23/0283; E21B 19/20

(57) ABSTRACT

Systems/methods of identifying critical spare parts for equipment aboard a MODU employ a quantitative approach that also accounts for failure probability and potential consequences of a decision whether to stock a spare part. This approach determines whether a loss risk from not having a spare part exceeds a loss risk from having the spare part, and whether a worst case loss risk from not having a spare part exceeds a predefined loss risk limit. The spare part is designated a critical spare part if both of the above conditions are satisfied. In some embodiments, a spare part may also be designated a critical spare part if equipment related to the spare part has a failure probability that exceeds a Safety Integrity Level (SIL) failure probability. Any spare part designated a critical spare part is identified to a supply chain system and/or an inventory tracking system for responsive actions.

### CROSS-REFERENCE TO RELATED APPLICATIONS

This application claims the benefit of and priority to U.S. Provisional Application No. 62/914,782, entitled “Critical Spare Part Identification Process for Mobile Offshore Drilling Units,” filed on Oct. 14, 2019, which is incorporated by reference herein in its entirety.

### TECHNICAL FIELD

The exemplary embodiments disclosed herein relate generally to systems and methods for maintenance of offshore drilling and exploration vessels, and more particularly to systems and methods for efficiently identifying and stocking critical replacement parts for equipment aboard such offshore vessels to minimize operational, safety, and environmental losses.

### BACKGROUND

Offshore drilling and exploration vessels, sometimes referred to as mobile offshore drilling units (MODU), are required to operate far away from land for extended periods of time. This is because offshore oil, gas, and other natural resources frequently lie deep beneath the ocean floor and are extremely difficult to reach. Finding and extracting these natural resources from such difficult locations can require the MODU to remain on station for months at a time. As such, the MODU needs to be as self-sustaining as possible while minimizing operational cost and maximizing operational efficiency and safety.

One aspect of a MODU that can significantly affect cost, efficiency, and safety is the type of equipment replacement parts, or equipment spare parts, carried aboard the MODU. It is particularly important that spare parts deemed to be critical are available when needed on board the MODU to avoid unacceptable losses related to equipment down time, safety hazards, and environmental losses. However, the decision whether to carry a particular spare part aboard the MODU must be balanced against the need to minimize operational cost.

Various spare part policies have been developed in the offshore oil and gas industry over the years. One approach involves performing a qualitative analysis that evaluates the risks and consequences associated with the decision whether to stock a particular spare part. However, while a qualitative risk analysis can provide an effective way to identify critical spare parts, this approach is inefficient and time consuming. For one thing, a proper risk analysis requires the participation of a cross-functional team whose members are not always available to participate during the required time period due to other conflicting obligations. Moreover, the implicit subjectivity of the participants can render the process susceptible to undesirable biases, such as group thinking, anchoring, loss aversion, confirmation, and the like.

An alternative approach entails performing a quantitative analysis. This approach relies on objective, measurable inputs for the spare part, such as lead time, material costs, operational losses, and the like, to identify critical spare parts. However, while an objective calculation based on lead time, costs, and other measurable inputs can greatly simplify the critical spare part identification process, this approach fails to take into account the probability of failure and potential consequences associated with not stocking a particular spare part based only on its measurable inputs.

Therefore, a need exists for improvements in MODU operations, particularly in the areas of identifying and stocking critical spare parts aboard a MODU.

### SUMMARY

Embodiments of the present disclosure provide systems and methods for efficiently identifying and stocking critical spare parts for equipment aboard a MODU and other offshore vessels to minimize operational, safety, and environmental losses. The embodiments disclosed herein employ a quantitative approach for identifying critical spare parts that also accounts for the probability of failure and potential consequences associated with a decision whether to stock a particular spare part. This approach determines whether a loss risk from not having a spare part exceeds a loss risk from having the spare part, and whether a worst case loss risk from not having a spare part exceeds a predefined loss risk limit. In some embodiments, the spare part is designated a critical spare part if both of the above conditions are satisfied, while in other embodiments, either condition alone may suffice to identify a critical spare part. In some embodiments, a spare part may also be designated a critical spare part if equipment related to the spare part has a failure probability that exceeds a preselected Safety Integrity Level (SIL) failure probability. Any spare part that is designated a critical spare part is then identified to a supply chain system and/or an inventory tracking system. The supply chain system operates to procure the critical spare part for the MODU, and the inventory tracking system operates to track the critical spare part to ensure it is stocked aboard the MODU.

In general, in one aspect, embodiments of the present disclosure relate to a critical spare parts identification system for a MODU. The system comprises, among other things, a communication interface, a processor coupled to the communication interface, and a storage device coupled to the processor. The storage device stores computer-readable instructions thereon that, when executed by the processor, causes the system to receive a list of spare parts from an external or internal system via the communication interface, each spare part being classified in one of several equipment groups. The computer-readable instructions, when executed by the processor, also causes the system to determine, for a spare part classified in a first equipment group or a second equipment group, (i) whether a loss risk from not stocking the spare part exceeds a loss risk from stocking the spare part, and (ii) whether a worst case loss risk from not stocking the spare part exceeds a predefined loss risk threshold. The computer-readable instructions, when executed by the processor, further causes the system to designate the spare part as a critical spare part if both (i) and (ii) are determined to be affirmative, and identify any spare part designated as a critical spare part to an inventory tracking system via the communication interface. The inventory tracking system thereafter operates to track any spare part designated as a critical spare part to ensure it is stocked aboard the MODU.

In general, in another aspect, embodiments of the present disclosure relate to a method of identifying critical spare parts for stocking aboard a MODU. The method comprises, among other things, receiving a list of spare parts from an external or internal system, each spare part being classified in one of several equipment groups, and determining, for a spare part classified in a first equipment group or a second equipment group, (i) whether a loss risk from not stocking the spare part exceeds a loss risk from stocking the spare part, and (ii) whether a worst case loss risk from not stocking the spare part exceeds a predefined loss risk threshold. The method further comprises designating the spare part as a critical spare part if both (a) and (b) are determined to be affirmative, and identifying any spare part designated as a critical spare part to an inventory tracking system. Any spare part designated as a critical spare part is then tracked using the inventory tracking system to ensure the spare part is stocked aboard the MODU.

In general, in yet another aspect, embodiments of the present disclosure relate to a system for stocking critical spare parts aboard a MODU. The system comprises, among other things, a subsystem operable to procure spare parts designated as critical spare parts for the MODU, and a subsystem operable to track spare parts designated as critical spare parts to ensure the critical spare parts are stocked aboard the MODU. The system further comprises a subsystem operable to identify critical spare parts from a list of spare parts for stocking aboard the MODU. This subsystem receives the list of spare parts from an external or internal system, each spare part being classified in one of several equipment groups. This subsystem then determines, for a spare part classified in a first equipment group or a second equipment group, (i) whether a loss risk from not stocking the spare part exceeds a loss risk from stocking the spare part, and (ii) whether a worst case loss risk from not stocking the spare part exceeds a predefined loss risk threshold. This subsystem thereafter designates the spare part as a critical spare part if both (i) and (ii) are determined to be affirmative, and identifies any spare part designated as a critical spare part to the subsystem operable to procure spare parts and the subsystem operable to track spare parts.

In accordance with any one or more of the foregoing embodiments, the determination of (i) is performed by determining whether a loss risk from Scenario 1 plus Scenario 2 exceeds a loss risk from Scenario 3 plus Scenario 4, where Scenario 1 assumes equipment related to the spare part has failed and the spare part is stocked, Scenario 2 assumes equipment related to the spare part has not failed and the spare part is stocked, Scenario 3 assumes equipment related to the spare part has failed and the spare part is not stocked, and Scenario 4 assumes equipment related to the spare part has not failed and the spare part is not stocked.

In accordance with any one or more of the foregoing embodiments, the determining the loss risk from each of Scenario 1, Scenario 2, Scenario 3, and Scenario 4 is performed by multiplying probable objective losses resulting from the equipment related to the spare part failing or not failing, respectively, for each scenario, times a probability of the equipment related to the spare part failing or not failing, respectively, for said scenario.

In accordance with any one or more of the foregoing embodiments, determining the worst case loss risk in (ii) is performed by assuming equipment related to the spare part has failed and the spare part is not stocked, then multiplying probable objective losses resulting from the equipment failing times a probability of the equipment failing.

In accordance with any one or more of the foregoing embodiments, the method and system further determine, for a spare part classified in a third equipment group, whether equipment related to the spare part has a failure probability that exceeds a preselected threshold failure probability, and designate the spare part as a critical spare part if the failure probability exceeds the preset threshold failure probability. In accordance with any one or more of the foregoing embodiments, the preselected threshold failure probability is a preselected safety standard threshold failure probability.

In accordance with any one or more of the foregoing embodiments, the method and system further identify any spare part designated as a critical spare part to a supply chain system, the supply chain system configured to procure any spare part designated as a critical spare part for the MODU.

### BRIEF DESCRIPTION OF THE DRAWINGS

For a more complete understanding of the exemplary disclosed embodiments, and for further advantages thereof, reference is now made to the following description taken in conjunction with the accompanying drawings in which:

FIG. 1 is a schematic diagram illustrating an exemplary MODU stocked with critical spare parts according to an embodiment of the present disclosure;

FIG. 2 is a block diagram illustrating a critical spare parts identification system according to an embodiment of the present disclosure;

FIG. 3 is a schematic diagram illustrating a critical failure bowtie risk reduction model according to an embodiment of the present disclosure;

FIG. 4 is a table illustrating an exemplary criticality matrix according to an embodiment of the present disclosure;

FIG. 5 is table illustrating a loss risk matrix according to an embodiment of the present disclosure;

FIG. 6 is a flowchart illustrating an exemplary method of classifying equipment according to an embodiment of the present disclosure;

FIGS. 7A-7B are exemplary lists illustrating exemplary equipment group classifications according to an embodiment of the present disclosure;

FIG. 8 is a flowchart illustrating an exemplary spare part evaluation tree according to an embodiment of the present disclosure; and

FIG. 9 is a flowchart illustrating an exemplary risk analysis tree according to an embodiment of the present disclosure; and

FIG. 10 is a flowchart illustrating a method of identifying critical spare parts according to an embodiment of the present disclosure; and

FIG. 11 is a table illustrating exemplary summary of critical spare parts for a MODU according to an embodiment of the present disclosure.

### DESCRIPTION OF EXEMPLARY EMBODIMENTS

The following discussion is presented to enable a person ordinarily skilled in the art to synthesize and use the exemplary disclosed embodiments. Various modifications will be readily apparent to those skilled in the art, and the general principles described herein may be applied to embodiments and applications other than those detailed below without departing from the spirit and scope of the disclosed embodiments as defined herein. Accordingly, the disclosed embodiments are not intended to be limited to the particular embodiments shown, but are to be accorded the widest scope consistent with the principles and features disclosed herein.

As used herein, a “critical” spare part generally refers to a replaceable component for a unique system or equipment, the availability of the component representing a mitigation barrier for a critical failure event. See, e.g., API RP 17N 5.4.5 (“Recommended Practice on Subsea Production System Reliability, Technical Risk, and Integrity Management”). At a high level, embodiments of the present disclosure provide automated (or semi-automated) systems and methods of defining, identifying, and optimizing inventory for such critical spare parts by using quantitative models based on risk analysis engineering and recognized technical standards. In this manner, the approach disclosed herein solve the current deficiencies in prior qualitative and quantitative approaches. In some embodiments, the approach described herein may be implemented on computer systems having computer memory, processors, displays and input and output devices. The approach may entail transmitting information regarding the identified critical spare parts to various networked computer systems, including inventory systems that track parts and equipment on board a MODU, and supply chain systems that procure parts and equipment for the MODU.

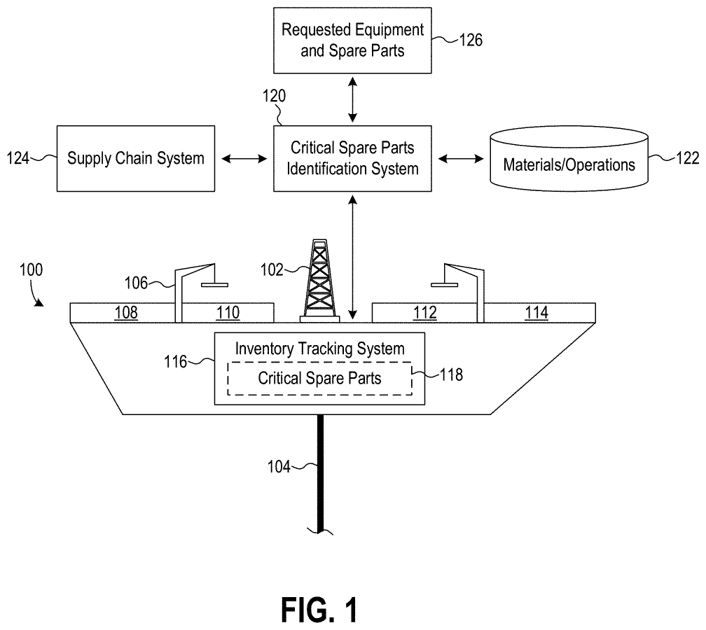

Referring now to FIG. 1, an exemplary MODU 100 is shown that has been stocked with critical spare parts identified in accordance with embodiments of the present disclosure. The exemplary MODU 100 in this example is a drill ship, but those having ordinary skill in the art will appreciate that the principles and teachings discussed herein are equally applicable to submersible rigs, semi-submersibles rigs, jack-up rigs, drilling barges, drilling platforms, and other types of MODUs. Drill ships like the MODU 100 are generally known in the art and therefore only a brief description is provided here for economy of the description.

As can be seen, the MODU 100 has one or more derricks 102 that are designed to support one more drill strings 104 for conducting various operations above or beneath the ocean floor. One or more cranes 106 are provided for lifting and transferring various drilling components 108 around the MODU, such as drill bits, tubulars, couplings, blowout preventers (BOP), and the like. Various types of equipment 110 are also carried onboard the MODU 100, as well as supplies 112 and other inventory 114 needed aboard the MODU.

An inventory tracking system 116 is used to track and manage the various components 108, equipment 110, supplies 112, and other inventory 114. In general, the inventory tracking system 116 keeps track of which parts are on board the MODU 100, the status of the parts (e.g., in storage, installed, in use, etc.), the location or whereabouts of the parts, and the like. These parts are typically added to the inventory tracking system 116 and, if not already aboard, are brought on board before the MODU 100 is deployed on any given offshore project. Additional parts may have course be added to the inventory tracking system 116 later as needed. Included among the parts tracked by the inventory tracking system 116 are critical spare parts 118 that are made certain to be carried aboard the MODU 100. Spare parts that are recommended, but not determined to be critical, may also be carried aboard the MODU 100 in some cases in addition to the critical spare parts 118.

In accordance with embodiments of the present disclosure, a critical spare parts identification system 120 identifies (or is used to identify) spare parts that constitute critical spare parts 118. The critical spare parts identification system 120 operates in conjunction with several other systems, including the inventory tracking system 116, a materials/operations database 122, and a supply chain system 124. The critical spare parts 118 are identified from a list of equipment and spare parts provided via an external and/or internal system 126. For example, some of the equipment and spare parts may be specified by a customer who has contracted the MODU operator for an offshore project, or some of the equipment and spare parts may be specified by third-party service providers, or both. The MODU operator may also specify some of the equipment and spare parts.

In operation, the critical spare parts identification system 120 inputs or otherwise receives the equipment and spare parts from the internal and/or external system 126. The system 120 thereafter automatically assesses (or is used to assess) a loss risk associated with stocking (or not stocking) the spare parts. The assessment is performed based on qualitative data about the spare parts, such as material costs, installation costs, installation time, procurement lead time, failure probabilities, and the like. This qualitative data may be obtained from the materials/operations database 122, for example, over suitable a communication link. The system 120 then automatically designates (or is used to designate) any spare part that satisfies certain loss risk requirements as a critical spare part 118. The system 120 also automatically identifies (or is used to identify) the critical spare parts 118 to the inventory tracking system 116, as well as the supply chain system 124 in some cases.

The inventory tracking system 116 automatically tracks (or is used to track) the critical spare parts 118 to ensure they are stocked aboard the MODU 100. For example, the inventory tracking system 116 may issue an alert or alarm to MODU personnel if a critical spare part 118 has not been brought aboard the MODU 100 by a certain cutoff date. The inventory tracking system 116 may also take certain responsive actions, such as preventing performance of certain operations (e.g., clearing inventory alarms), and the like. In a similar manner, the supply chain system 124 automatically orders (or is used to order) the critical spare parts 118 for the MODU 100. The supply chain system 124 may issue an alert or alarm to procurement personnel if a critical spare part 118 has not been procured for the MODU 100 by a certain cutoff date. The supply chain system 124 may also take certain responsive actions, such as blocking performance of certain operations (e.g., releasing related inventory to MODU), and the like.

In the FIG. 1 example, the critical spare parts identification system 120 is depicted as being a separate system that is connected to the inventory tracking system 116, the material status operations database 122, the supply chain system 124, and the external and/or internal system 126. The connection may be any suitable connection, such as a wired (e.g., cables, landlines etc.) or wireless (e.g., cellular, satellite, etc.) communication link (not expressly labeled). The wired or wireless communication links may include an internal intranet, an external network, such as the Internet, or both.

In alternative embodiments, the critical spare parts identification system 120 may be integrated with the inventory tracking system 116, the material/operations database 122, and/or the supply chain system 124. For example, the inventory tracking system 116, the critical spare parts identification system 120, the material/operations database 122, and the supply chain system 124 may form part of an enterprise-wide asset management system. An example of such an asset management system may be the IBM® Maximo system, which is a cloud-based Computerized Maintenance Management System (CMMS) available from International Business Machines Corporation.

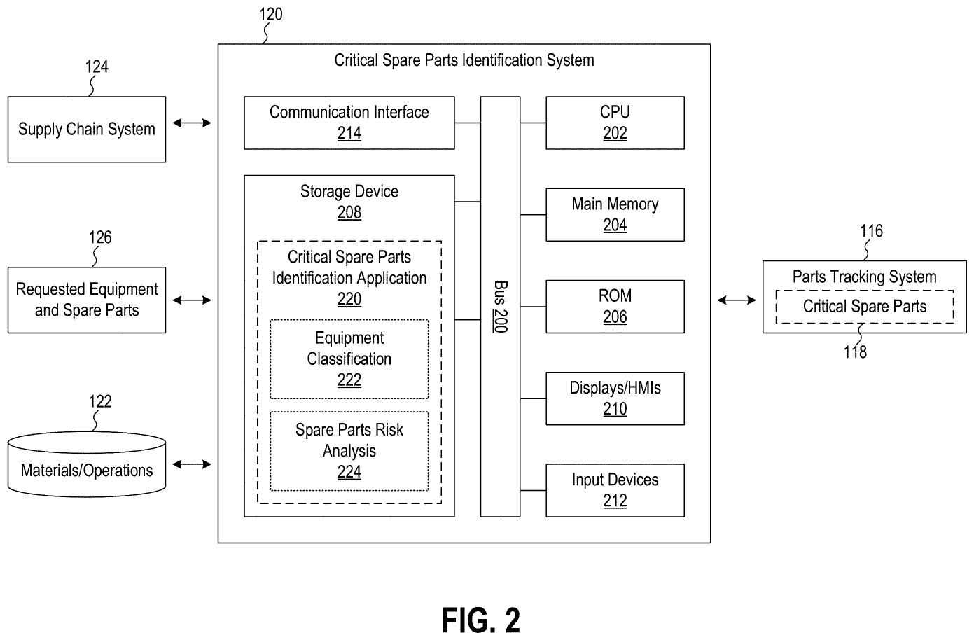

FIG. 2 illustrates an exemplary implementation of the critical spare parts identification system 120 according to the embodiments disclosed herein. The system 120 may include a conventional computing system, such as a workstation, desktop, or laptop computer, or it may include a custom computing system developed for a particular application, or maybe a cloud-based system or other shared-resources system. In a typical arrangement, the system 120 includes a bus 200 or other communication pathway for transferring information among other components within the system 120, and a CPU 202 coupled with the bus 200 for processing the information. The system 120 may also include a main memory 204, such as a random access memory (RAM) or other dynamic storage device coupled to the bus 200 for storing computer-readable instructions to be executed by the CPU 202.

The system 120 may further include a read-only memory (ROM) 206 or other static storage device coupled to the bus 200 for storing static information and instructions for the CPU 202. A computer-readable storage device 208, such as a nonvolatile memory (e.g., Flash memory) drive or magnetic disk, may be coupled to the bus 200 for storing information and instructions for the CPU 202. The CPU 202 may also be coupled via the bus 200 to a display or HMI 210 for displaying information and content to a user. The user may then interact with the system 120 via the display or HMI 210 based on information and content displayed. One or more input devices 212, including a touchscreen, alphanumeric and other keyboards, mouse, trackball, cursor direction keys, and so forth, may also be coupled to the bus 200 for transferring information and command selections to the CPU 202. A communication interface 214 may be provided for allowing the system 120 to communicate with an external system or network.

The term “computer-readable instructions” as used above refers to any instructions that may be performed by the CPU 202 and/or other components. Similarly, the term “computer-readable medium” refers to any storage medium that may be used to store the computer-readable instructions. Such a medium may take many forms, including, but not limited to, non-volatile media, volatile media, and transmission media. Non-volatile media may include, for example, optical or magnetic disks, such as the storage device 208. Volatile media may include dynamic memory, such as main memory 204. Transmission media may include coaxial cables, copper wire and fiber optics, including the wires of the bus 200. Transmission itself may take the form of electromagnetic, acoustic or light waves, such as those generated for radio frequency (RF) and infrared (IR) data communications. Common forms of computer-readable media may include, for example, magnetic medium, optical medium, memory chip, and any other medium from which a computer can read.

In accordance with the disclosed embodiments, a critical spare parts identification application 220, or the computer-readable instructions therefor, may also reside on or be downloaded to the storage device 208 for execution. The critical spare parts identification application 220 may be a standalone application or it may be part of a larger suite of applications that may be used to manage assets across an enterprise. Such an application 220 may be implemented in any suitable computer programming language or software development package known to those having ordinary skill in the art, including various versions of C, C++, Java, Python, and the like. Users may then use the application 220 for critical spare parts identification, as disclosed and described herein.

As FIG. 2 shows, the critical spare parts identification application 220 has two main modules, an equipment classification module 222 and a spare parts risk analysis module 224. The equipment classification module 222 is generally responsible for determining a group classification for the various equipment used aboard the MODU 100. The group classification in turn determines how the loss risk associated with the spare parts for the equipment is evaluated. The spare parts risk analysis module 224 is responsible for performing the loss risk evaluation for the spare parts based on the group classification of the equipment. The loss risk evaluation uses objective losses resulting from equipment failure coupled with a probability of failure. If the loss risk for a given spare part satisfies certain loss risk requirements, then the critical spare parts identification application 220 designates (or is used to designate) that spare part as a critical spare part 118.

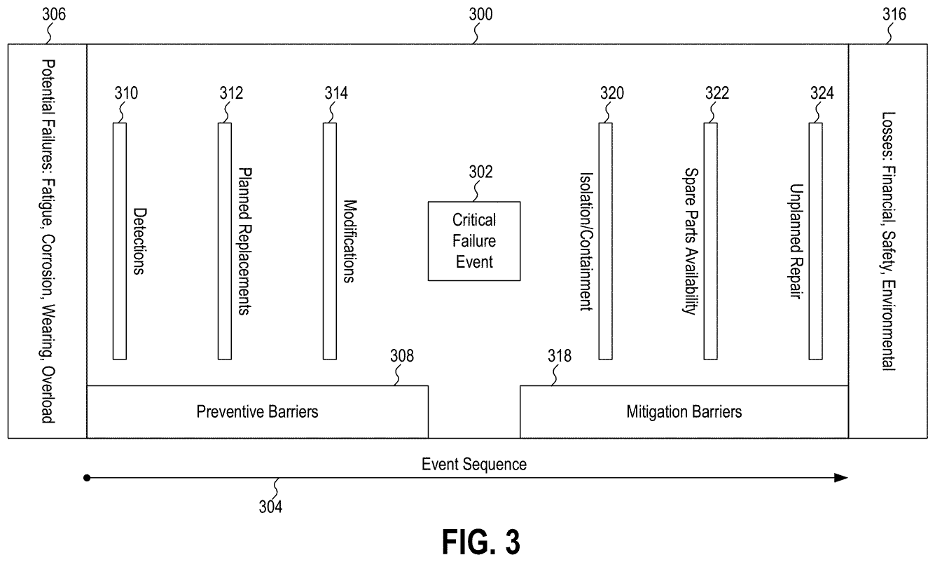

Operation of the critical spare parts identification application 220 is described by first providing some background, starting with FIG. 3. This figure depicts what is sometimes referred to by offshore vessel operators as a “bowtie” critical failure risk reduction model 300. Central to the model 300 is a critical failure event 302, with events leading up to the failure event and events that occur afterward going from left to right, as indicated by arrow 304. Consistent with this scheme, potential failures that may lead to the critical failure event 302 are shown on the left at 306, examples of which include component fatigue, parts corrosion, equipment wearing, and overload. A number of preventive barriers 308 may be implemented to help prevent the potential equipment failures 306, including failure detection systems 310, planned replacement schedules 312, and design modifications 314. Losses resulting from the critical failure event 302 are shown on the right at 316, examples of which include financial losses, safety losses, and environmental losses. A number of mitigation barriers 318 may be erected to help minimize (although not prevent) the losses 316, including failure isolation/containment 320, replacement or spare parts availability 322, and an ability to improvise and make unplanned repairs 324.

In the “bowtie” model 300 and similar models used in the industry, much of the focus is on critical failures, not on critical spare parts. The critical spare parts represent merely one of several mitigation barriers for the failures. These mitigation barriers cannot prevent a critical failure; rather, they function to minimize losses after the critical failure has already occurred. There are currently no models or schemes in the industry that have critical spare parts as a main focus.

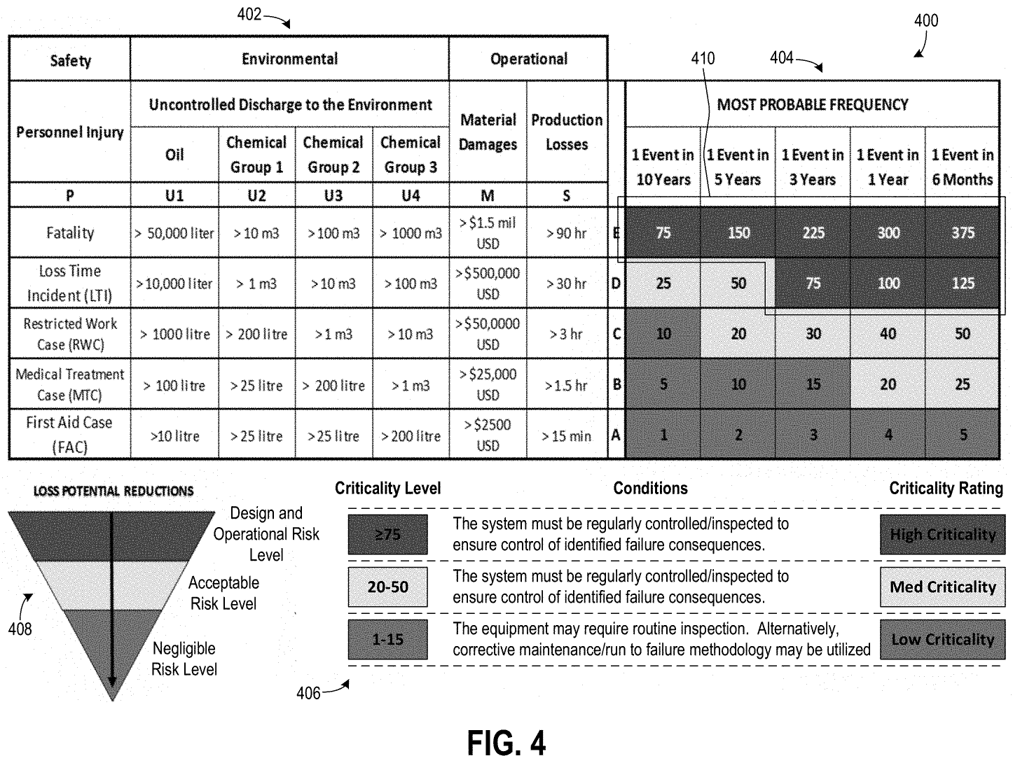

Some schemes, like the one shown in FIG. 4, focus on equipment criticality (not spare part criticality). In FIG. 4, an exemplary criticality matrix 400 is shown that emphasizes equipment criticality. The criticality matrix 400 assigns different levels of criticality to equipment based on the types of losses that may result if the equipment fails. The matrix 400 has two main sections, a loss section 402 that shows various potential losses due to equipment failure, and a probable failure frequency section 404 that shows several probable failure frequencies. Within the losses section 402, the losses are grouped according to the types of losses, including safety losses, environmental losses, and operational losses. Within environmental losses, the losses are further grouped into several subgroups, such as oil and chemical groups 1-3. Likewise, within operational losses, the losses are further broken out into material damages and production losses. For each type of loss, the probable failure frequency section 404 shows the criticality level assigned by the MODU operator for a given probable failure frequency.

For example, looking at fatality losses, any equipment, the failure of which leads to a fatality loss once in 10 years, is assigned a criticality level of 75. On the other hand, any equipment, the failure of which leads to a fatality loss once in 5 years, is assigned a criticality level of 150, which is double the criticality level of the equipment that leads to a fatality loss once every 10 years, and so on. The specific criticality levels assigned to the equipment for each probable frequency may be defined as needed by the MODU operator. And the MODU operator may define the criticality levels according to its unique operational requirements and circumstances (e.g., shallow water drilling versus ultra-deep water drilling, etc.). Thus, the criticality matrix 400 for one MODU operator may differ greatly in content from the criticality matrix 400 for another MODU operator.

A legend 406 for the criticality matrix 400 shows several threshold criticality levels and their associated criticality ratings, as defined by the MODU operator. In this example, the MODU operator has set criticality levels greater than or equal to 75 as high criticality, criticality levels between 20 and 50 as medium criticality, and criticality levels between 1 and 15 as low criticality. For example, any equipment, the failure of which leads to $500,000 in material loss once every 5 years, has a medium criticality, whereas any equipment, the failure of which leads to $500,000 in material loss once every 3 years, has a high criticality, and so forth. A diagram 408 graphically depicts the relative loss potentials for each of the criticality ratings compared to the other criticality ratings. The above scheme results in a zone of high criticality 410 that may be used to identify critical spare parts, as discussed below.

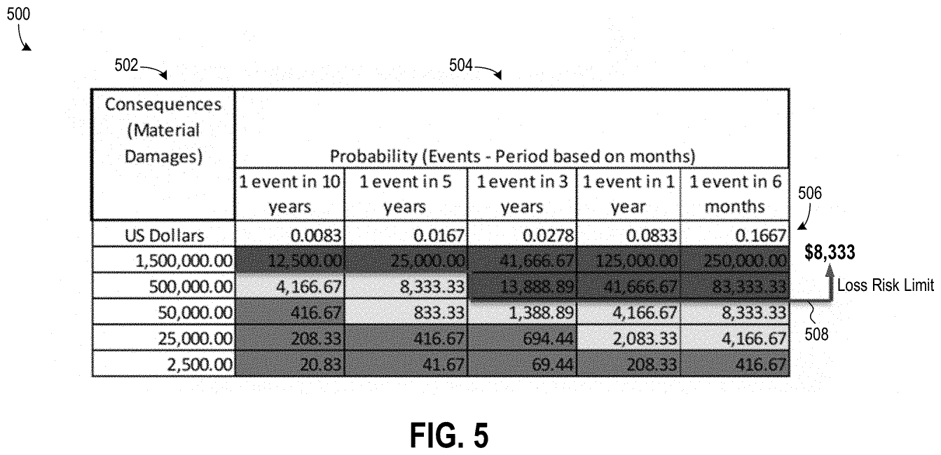

Referring now to FIG. 5, an exemplary risk aversion matrix 500 can be seen that is similar to the criticality matrix 400 shown in FIG. 4. This risk aversion matrix 500 also includes two main sections, a consequences section 502 that shows the consequences of a particular type of loss, and a probability section 504 that shows the loss risk for several probable frequencies. The particular loss type used in this example is the material damages loss from the criticality matrix 400 of FIG. 4, but alternative loss types (e.g., uncontrolled oil discharge to the environment, production losses, etc.) may also be used. The loss risk may then be calculated by multiplying the material damages loss by the probability of the loss, with months as the unit of time. The probability of loss is indicated at 506 (e.g., 0.0083, 0.0167, 0.0278, 0.833, and 0.1667). For example, any equipment, the failure of which leads to a loss of $1.5 million once in 10 years, has a loss risk of about $12,500 (loss risk=$1.5 mil×(1 event/10 years)×(1 year/12 months)≈$1.5 mil×0.0083≈$12,500).

Once the loss risks for the material damages have been calculated, a loss risk limit or threshold may be defined for the MODU operator by applying the high criticality zone 410 from FIG. 4 to the calculated loss risks. Doing so produces a loss risk threshold of about $8,333 in the present example, as indicated at 508. Thus, for the present example, any equipment, the failure of which produces a loss risk of $8,333 or higher, will be considered high criticality equipment. The loss risk threshold 508 for equipment may then be used by (or in) the critical spare parts identification application 220 (and system 120) to make a determination whether a spare part is a critical spare part, as described further herein.

Determining whether a spare part is critical begins by classifying the spare part into one of several groups based the functional areas of the equipment. In general, any given equipment or system on the MODU 100 performs its function either in an operating mode or from a standby mode. Additionally, the equipment and system can performs its function either continuously or on demand (i.e., when it is used). Once classified, the equipment's or system's functional area is transferable to the parts that compose the equipment or system. In the following example, MODU equipment and systems, and hence their spare parts, are classified into one of four groups based on their functional areas:

Group 1—Operating functional areas in which equipment failing to operate causes an interruption of normal drilling or other operation. Examples of equipment in this group include drawwork, top-drive, and derrick pipe handling system.

Group 2—Standby functional areas in which equipment failing to operate on-demand causes an interruption of normal drilling or other operation. Examples of equipment in this group include BOP systems and choke and kill systems.

Group 3—Standby functional areas in which equipment failing to operate on demand does not cause an interruption of normal drilling or other operation. Primary examples of equipment in this group includes safety systems, such as lifeboats, smoke detectors, and emergency switchboards.

Group 4—Operating functional areas in which equipment failing to operate on demand does not cause an interruption of normal drilling or other operation, meaning redundancy is present. Examples of equipment in this group include mud pumps, electric generators, and water pumps.

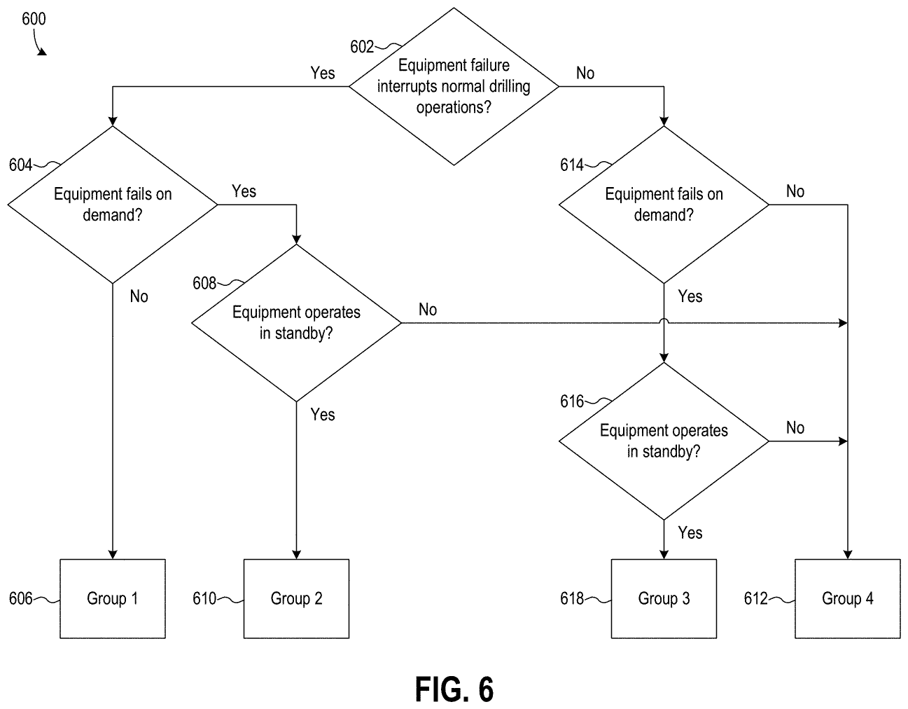

The process of classifying MODU equipment and systems into one of the above equipment groups is reflected in FIG. 6, which illustrates an exemplary method 600 that may be used to classify the equipment and systems, and hence their spare parts. It should be noted that although a number of discrete blocks are shown in FIG. 6, those having ordinary skill in the art will understand that for all figures herein, any block may be divided into several constituent blocks, or combined with another block to form a superblock, within the scope of the present disclosure.

The method 600 generally begins at 602 where a determination is made whether an equipment's failure would interrupt normal drilling or other operations. If the determination results in a Yes, then at 604, a determination is made whether the equipment is a type of equipment that fails to operate on-demand (i.e., when used). If the determination results in a No, then at 606 the equipment is classified as a Group 1 equipment. If the determination at 604 results in a Yes, then a determination is made at 608 whether the equipment operates on-demand. If the determination results in a Yes, then at 610 the equipment is classified as a Group 2 equipment. If the determination at 608 results in a No, then at 612 the equipment is classified as a Group 4 equipment.

On the other hand, if the determination at 602 results in a No, then a determination is made at 614 whether the equipment fails on demand. If the determination results in a No, then at 612 the equipment is classified as a Group 4 equipment. If the determination at 614 results in a Yes, then a determination is made at 616 whether the equipment operates in standby. If this determination results in a No, then again at 612 the equipment is classified as a Group 4 equipment. If the determination at 616 results in a Yes, then at 618 the equipment is classified as a Group 3 equipment.

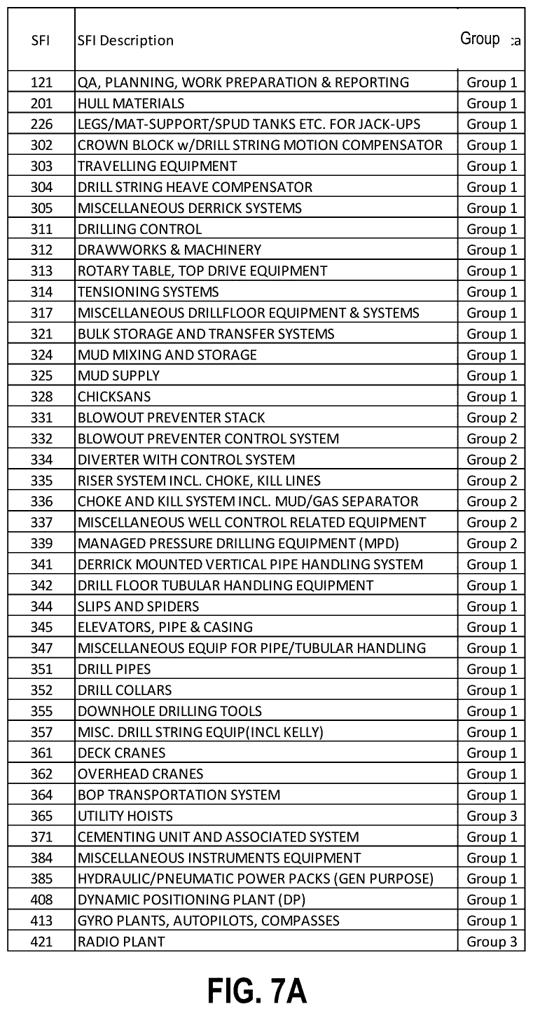

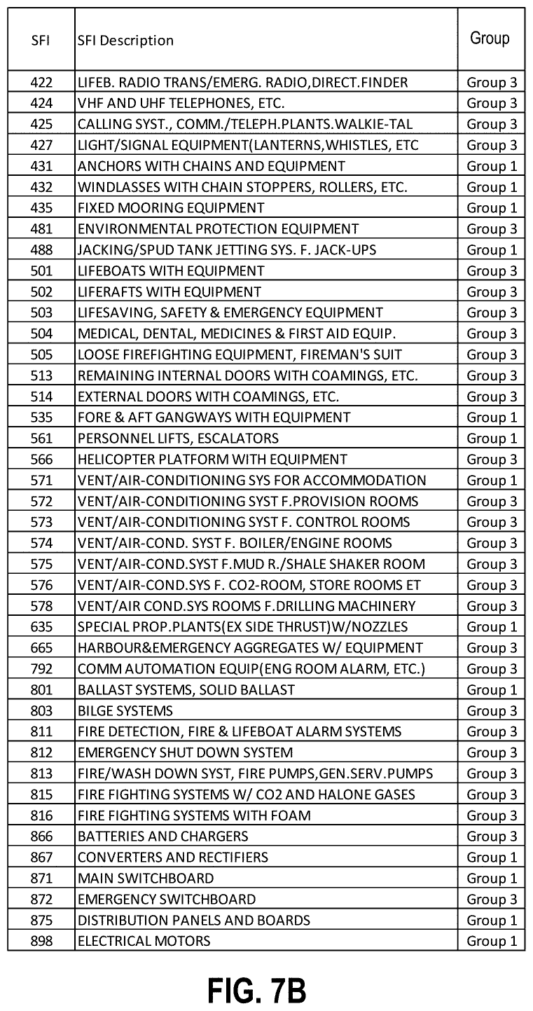

FIGS. 7A and 7B illustrate exemplary listings of MODU equipment and their group classifications. For the purposes herein, the spare parts for each equipment has the same group classifications as the equipment. In the figure, the various equipment are listed according to their SFI codes and descriptions, as commonly done in the industry. SFI (Skipsteknisk Forskningsinstitutt) is an international coding standard that is widely used for maritime vessels. It provides a technical account structure that covers all aspects of ship and rig specification, and can be used as a basic standard for all systems in the shipping and offshore industry. Note that the classifications in the lists may be revised from time to time as needed. Those skilled in the art will also appreciate that alternative classifications besides the ones shown here (e.g., Groups 1-5, Groups 1-6, etc.) may also be used within the scope of the disclosed embodiments.

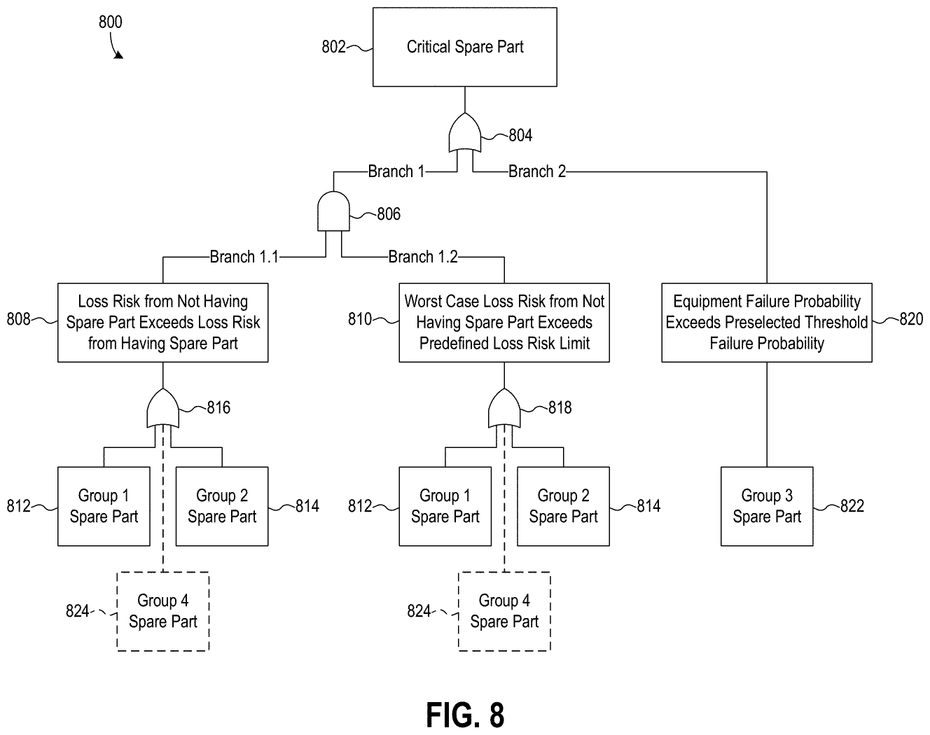

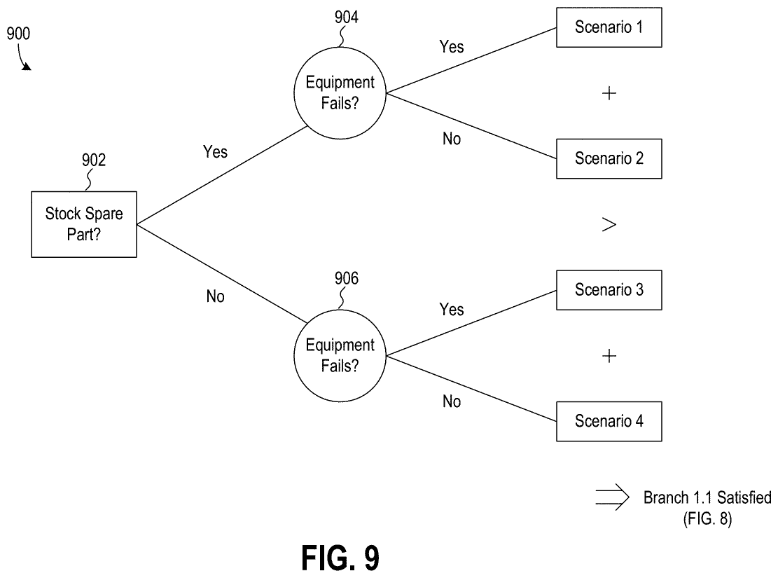

Turning next to FIG. 8, assuming the equipment is classified into one of Groups 1-4, the critical spare parts identification application 220 may employ a spare part evaluation tree 800 to evaluate the spare parts for the equipment. In general, the evaluation tree 800 has two main requirements for a spare part to be designated a critical spare part. The first requirement is the loss risk from not having the spare part must be higher than the loss risk from having the spare part. The second requirement is the loss risk from not having the spare part must be higher than a loss risk limit or threshold. In preferred embodiments, both requirements need to be met in order for a spare part to be designated critical, but depending on the specific application, it is possible for either requirement alone to be used.

In the tree 800, spare parts are designated as critical spare parts at 802. There are two paths to reach the critical spare parts designation, Branch 1 and Branch 2. Either path may be taken to reach the critical spare parts designation, as indicated by an OR gate 804. Branch 1 in turn also has two sub-branches, Branch 1.1 and Branch 1.2. However, both sub-branches are required to reach the critical spare parts designation (via Branch 1) in this example, as indicated by an AND gate 806. Branch 1.1 requires that the loss risk from not having a spare part exceed the loss risk from having the spare part. This is the first requirement mentioned above and is indicated at 808. Branch 1.2 requires that the loss risk from not having the spare part exceed a loss risk limit or threshold. This is the second requirement mentioned above and is indicated at 810.

In the example of FIG. 8, only spare parts for equipment from Groups 1, 2, or 3 are evaluated. More specifically, spare parts classified as Group 1 (812) or Group 2 (814) are evaluated through Branch 1.1 and Branch 1.2, as indicated by OR gates 816 and 818, while spare parts classified as Group 3 (822) are evaluated through Branch 2. For a spare part classified as Group 1 or Group 2, the spare part must meet both the requirements at 808 and at 810 in this example to reach the critical spare parts designation at 802. If the spare part meets only one of the requirement, then it may be designated a recommended spare part, but not a critical spare part.

On the other hand, the Branch 2 evaluation requires only that the failure probability of the equipment related to the spare part be higher than a preselected threshold probability failure, indicated at 820. The reason is because only spare parts from Group 3 are evaluated through this branch, and most of the equipment from Group 3 relate to safety, so the path for these spare parts to be designated a critical spare part should be less restrictive.

Spare parts for equipment from Group 4 (824) typically have negligible loss risk relative to the other groups and thus may be assumed to be non-critical. As an option, however, it may be desirable to evaluate spare parts for equipment from Group 4 as well, depending on the particular application. In such embodiments, the critical spare parts identification application 220 may perform the evaluation of spare parts for equipment from Group 4 in the same manner as spare parts for equipment from Group 1 or Group 2.

FIG. 9 shows an exemplary risk analysis tree 900 that may be used by (or in) the critical spare parts identification application 220 to perform the Branch 1.1 evaluation referenced above. The risk analysis tree 900 basically provides a formal or structured way to evaluate the loss risk from stocking or not stocking the Group 1 or Group 2 spare part, as indicated at 902. The analysis considers the probable objective losses from stocking or not stocking the Group 1 or Group 2 spare part in conjunction with a failure probability of the equipment related to the spare part. Probable objective losses as used herein are losses that are quantifiable and more likely than not to occur if the equipment fails, and may be based on real-world experience, simulations, observations, and/or industry data collected over time.

In FIG. 9, if the spare part is stocked (Yes branch), then the analysis looks at the objective losses that would occur if the equipment thereof fails, indicated at 904. If the equipment fails and the spare part is stocked (Yes branch), then this leads to Scenario 1. If the equipment does not fail and the spare part is stocked (No branch), then this leads to Scenario 2. Conversely, if the spare part is not stocked (No branch), then the analysis again looks at the objective losses that would occur if the equipment thereof fails, indicated at 906. If the equipment fails and the spare part is not stocked (Yes branch), then this leads to Scenario 3. If the equipment does not fail and the spare part is not stocked (No branch), then this leads to Scenario 4. Each scenario is described in more detail below.

Scenario 1: Equipment fails and the spare part is stocked. In this case, objective losses mainly include the cost of the spare part and stocking it, cost of installing the spare part, and operational losses due to repair time.

Scenario 2: Equipment does not fail and the spare part is stocked. In this case, objective losses mainly include the cost of the spare part and stocking it.

Scenario 3: Equipment fails and the spare part is not stocked. This represents potentially the worst case scenario because objective losses include the cost of the spare part, cost of installing the spare part, operational losses due to repair time, plus operational losses due to waiting for the part to be delivered to the MODU.

Scenario 4: Equipment does not fails and the spare part is not stocked. This represents the best case scenario because losses basically equal zero.

In the above example, if the loss risk of Scenario 1 plus the loss risk of Scenario 2 is higher than the loss risk of Scenario 3 plus the loss risk of Scenario 4, then the requirement of Branch 1.1 is satisfied. In some embodiments, the loss risk associated with each scenario may be calculated by multiplying the probable objective losses, using the appropriate loss units (e.g., dollars), times the probability of occurrence of the scenario (e.g., failure of equipment). In the case of material damages, the loss risk may be expressed in dollars, since probability is a non-dimensional quantity. Table 1 below shows a simplified example for illustrative purposes.

TABLE 1
Objective Losses for Exemplary Spare Part

| No. | Description | Value |
|---|---|---|
| 1. | Probability of equipment failure | 0.05 |
| 2. | Cost of spare part | $1,000 |
| 3. | Cost of stocking spare part | $1,000 |
| 4. | Cost of installing spare part | $1,000 |
| 5. | Time to install spare part | 1 day |
| 6. | Lead time to obtain spare part | 7 days |

In the table, the failure probability of the equipment is 0.05 (i.e., 5 fails per 100 demands). The cost of the spare part, cost of stocking the spare part, and cost of installing the spare part are each set at $1,000. Other objective losses may be calculated from the time to install the spare part and the lead time to obtain the spare part. The costs and failure probabilities associated with various equipment typically have to be tracked by the MODU operator and thus are usually readily available or may be quickly calculated. A key cost that is tracked and readily available is the daily operational cost for the MODU. Assume in this simplified example that the daily operational cost is $100,000. Based on this example, the loss risks for the various scenarios are shown in Table 2 below.

TABLE 2
Loss Risks for Exemplary Spare Part

| Scenario | Objective Losses × Probability of Losses | Loss Risk |
|---|---|---|
| 1 | ($3,000 + (1 × $100,000)) × 0.05 | $5,150 |
| 2 | $2,000 × 0.95 | $1,900 |
| 3 | ($3,000 + (1 × $100,000) + | $40,150 |
| | (7 × $100,000)) × 0.05 | |
| 4 | $0 × 0.95 | $0 |

In the table, the loss risk for Scenario 1 is the cost of the spare part, cost of stocking the spare part, cost of installing the spare part, and operational loss due to the delay to install the spare part, multiplied by the probability of the equipment failing. The loss risk for Scenario 2 is simply the cost of the spare part and the cost of stocking the spare part multiplied by the probability of the equipment not failing (i.e., 1-0.05), and so forth for Scenarios 3 and 4. As can be seen, the loss risk from not having the exemplary spare part (Scenarios 3 and 4) is much higher than the loss risk from having the exemplary spare part (Scenarios 1 and 2). Thus, the requirement of Branch 1.1 is satisfied with respect to the exemplary spare part.

As for Branch 1.2, this evaluation may be performed by (or in) the critical spare parts identification application 220 by comparing the worst case loss risk for a given spare part, Scenario 3, with the loss risk limit 508 from FIG. 5. In this example, the worst case loss risk for the exemplary spare part is $40,150, which is much higher than the $8,333 loss risk limit from FIG. 5, so the requirement of Branch 1.2 is satisfied.

The loss risk from a spare part belonging to equipment in Group 4 may be evaluated in the same manner as above, in some embodiments.

In the foregoing embodiments, various methods known to those having ordinary skill in the MODU art may be used to determine the probability of failure for any given equipment. For example, the probability of failure for a given equipment may be determined by following the recommendations of NASA standard NASA/SP-2009-569 (“Bayesian Inference for NASA Probabilistic Risk and Reliability Analysis”), and similar risk and reliability probability standards.

Based on NASA/SP-2009-569, the probability of failure for equipment in Group 1 may be determined using a Poisson distribution, with the failure rate distributed according to a Gamma distribution at 60% credible interval adjusted by conditional probabilities with conjugate prior Gamma distribution with parameters: alphapost=alphaprior+x, and betapost=betaprior+t, where x is the count of failures, t is the operation time, alphaprior is the average of the failure counts within the rest of the MODU rigs in the fleet (can be set to 0.5 if data is not available), and betaprior is the average of the operation time within the rest of the MODU rigs in the fleet (can be set to 0 if data is not available).

Group 2 equipment failure probability may be determined using a binomial distribution, with the failure count and number of demands distributed according to a Beta distribution at 60% credible interval adjusted by conditional probabilities with conjugate prior Beta distribution with parameters: alphapost=alphaprior+x, and betapost=betaprior+n−x, where x is the count of failures, n is the number of demands, alphaprior is the average of the failure counts within the rest of the MODU rigs in the fleet (can be set to 0.5 if data is not available), and betaprior is the average number of demands within the rest of MODU the rigs in the fleet (can be set to 0.5 if data is not available).

For Branch 2, since the equipment in Group 3 mostly relate to safety, the spare parts evaluation performed by (or in) the critical spare parts identification application 220 differs from the Branch 1 evaluations. In some embodiments, the Branch 2 evaluation only uses equipment failure probability as the loss risk, with the loss risk limit being based on an industry standard instead of a monetary loss risk. For example, SIL 2 (Safety Integrity Level 2) may be used as the loss risk limit for Branch 2, which allows 1 fail per 1,000 demands (i.e., 0.001). Thus, if the probability of failure for a given equipment in Group 3 is higher than 0.001, then the spare part for that equipment is considered to satisfy the Branch 2 requirement. The probability of failure for equipment in Group 3 may be determined in the same manner as equipment in Group 2, in some embodiments.

For Group 4 equipment, the probability of failure may be determined in the same manner as Group 3 equipment, but taking into consideration the redundancy present in the equipment. Therefore, the probability of failure for Group 4 equipment may be determined as: P(FG4)=[P(FG3)]ⁿ, where P(FG4) is the Group 4 failure probability being determined, P(FG3) is the Group 3 failure probability discussed above, and n is the number of subsystems that conform to the redundancy, with n being equal to 1 when no redundancy is present.

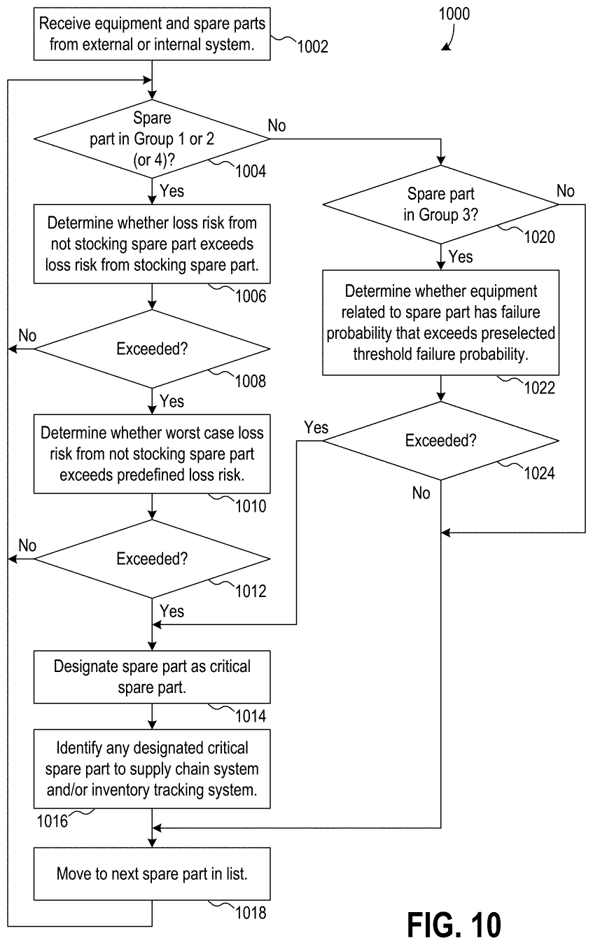

Turning now to FIG. 10, an exemplary flow diagram generally illustrating a method 1000 is shown that may be used to implement some of the embodiments discussed herein. The method begins at 1002 where the critical spare parts identification system receives the equipment required by a given MODU for a particular offshore project along with the spare parts for the equipment. The equipment and spare parts may be received from an external system, such as a system belonging to a customer or contractor, or from an internal system, such as a system belonging to the MODU operator itself. At 1004, the critical spare parts identification system determines, for each spare part, whether the spare part belongs to Group 1 or Group 2 (or optionally Group 4). This may involve simply checking the group classification of the equipment related to the spare part, as the spare part may be assumed to belong to the same group as its equipment. In cases where the equipment does not have a group classification, the critical spare parts identification system may classify (or be used to classify) the equipment according to the method shown in FIG. 6.

A spare part belonging to Group 1 or Group 2 is then evaluated at 1006 to determine whether a loss risk from not stocking the spare part exceeds a loss risk from stocking spare part. A spare part belonging to Group 4 may optionally be included in this evaluation in some embodiments. In some embodiments, the critical spare parts identification system may perform the evaluation by determining whether a loss risk from Scenario 1 plus Scenario 2 exceeds a loss risk from Scenario 3 plus Scenario 4, as described above. If the evaluation is affirmative (at 1008), then the spare part is further evaluated at 1010 to determine whether a worst case loss risk from not stocking spare part exceeds a predefined loss risk limit. In some embodiments, the critical spare parts identification system may perform this evaluation by assuming Scenario 3 and comparing the loss risk against the loss risk limit 508 from FIG. 5.

If the evaluation at 1010 is affirmative (at 1012), then the spare part is designated as a critical spare part at 1014. The critical spare parts identification system thereafter identifies any designated critical spare part to a supply chain system and/or an inventory tracking system at 1016. The supply chain system thereafter operates to procure any spare part designated as a critical spare part for the MODU, and the inventory tracking system thereafter operates to track any spare part designated as a critical spare part to ensure the spare part is stocked aboard the MODU. At 1018, the critical spare parts identification system moves to the next spare part in the list of spare parts, and returns to 1004 to repeat the process.

If the spare part does not belong to Group 1 or Group 2 (or Group 4), then a determination is made at 1020 whether the spare part belongs in Group 3. If the determination is affirmative, then the critical spare parts identification system determines whether equipment related to spare part has a failure probability that exceeds a preselected threshold failure probability at 1022. In some embodiments, the preselected threshold failure probability may be a SIL level 2 failure probability. If the determination is affirmative (at 1024), then the spare part is designated as a critical spare part at 1014, and the critical spare parts identification system identifies the designated critical spare part to the supply chain system and/or the inventory tracking system at 1016. Otherwise, the critical spare parts identification system moves to the next spare part in the list of spare parts, and returns to 1004 to repeat the process.

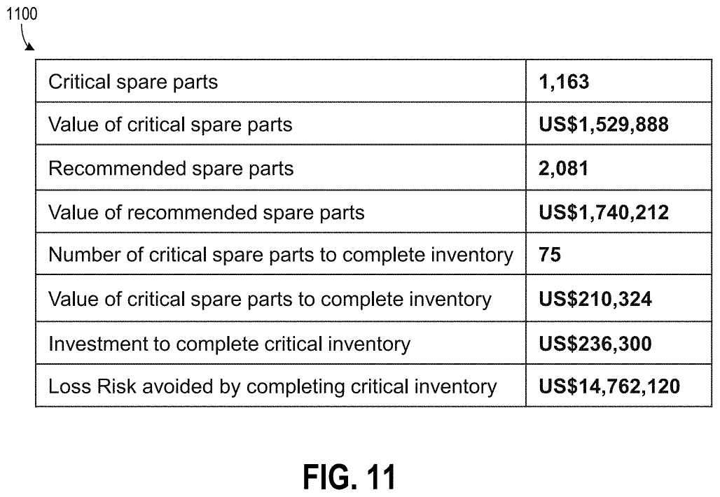

FIG. 11 illustrates exemplary results for a given MODU in the form of a chart 1100 produced using embodiments of the present disclosure. The results show the number of critical spare parts, value of the critical spare parts, number of recommended spare parts, value of the recommended spare parts, number of critical spare parts to complete critical inventory, value of critical spare parts to complete critical inventory, investment to complete critical inventory, and risk avoided by completing critical inventory. As can be seen, the critical spare parts identification system has identified 1,163 critical spare parts from 2,081 recommended spare parts. Thus, only a little more than half of the number of recommended spare parts were determined to be critical spare parts that need to be stocked aboard the MODU. Most of these 1,163 critical spare parts have already been procured by the supply chain system, as recorded by the inventory tracking system, except for 75 critical spare parts that are still needed to be brought aboard the MODU to complete the critical inventory. The material cost of the critical spare parts is $1,529,888, whereas the material cost of all recommended spare parts is $1,740,212. The material cost of the remaining 75 critical spare parts is $210,324, and the investment needed to bring remaining critical spare parts aboard, including material costs, is $236,300. Finally, the loss risk avoided by completing the critical inventory is $14,762,120.

While the present disclosure has been described with reference to one or more particular embodiments, those skilled in the art will recognize that many changes may be made thereto without departing from the spirit and scope of the description. Each of these embodiments and obvious variations thereof is contemplated as falling within the spirit and scope of the claimed invention, which is set forth in the following claims.

What is claimed is:

1. A critical spare parts identification system for a mobile offshore drilling unit (MODU), comprising:
a communication interface;
a processor coupled to the communication interface; and
a storage device coupled to the processor, the storage device storing computer-readable instructions thereon that, when executed by the processor, causes the system to:
receive a list of spare parts from an external or internal system via the communication interface, each spare part being classified in one of several equipment groups;
determine, for a spare part classified in a first equipment group or a second equipment group, (a) whether a loss risk from not stocking the spare part exceeds a loss risk from stocking the spare part, and (b) whether a worst case loss risk from not stocking the spare part exceeds a predefined loss risk threshold;
designate the spare part as a critical spare part if both (a) and (b) are determined to be affirmative; and
identify any spare part designated as a critical spare part to an inventory tracking system via the communication interface, the inventory tracking system configured to track and ensure any spare part designated as a critical spare part is stocked aboard the MOD U.

2. The system according to claim 1, wherein the processor causes the system to determine (a) by determining whether a loss risk from Scenario 1 plus Scenario 2 exceeds a loss risk from Scenario 3 plus Scenario 4, where Scenario 1 assumes equipment related to the spare part has failed and the spare part is stocked, Scenario 2 assumes equipment related to the spare part has not failed and the spare part is stocked, Scenario 3 assumes equipment related to the spare part has failed and the spare part is not stocked, and Scenario 4 assumes equipment related to the spare part has not failed and the spare part is not stocked.

3. The system according to claim 2, wherein the processor causes the system to determine the loss risk from each of Scenario 1, Scenario 2, Scenario 3, and Scenario 4 by multiplying probable objective losses resulting from the equipment related to the spare part failing or not failing, respectively, for each scenario, times a probability of the equipment related to the spare part failing or not failing, respectively, for said scenario.

4. The system according to claim 1, wherein the processor causes the system to determine the worst case loss risk in (b) by assuming equipment related to the spare part has failed and the spare part is not stocked, then multiplying probable objective losses resulting from the equipment failing times a probability of the equipment failing.

5. The system according to claim 1, wherein the processor further causes the system to determine, for a spare part classified in a third equipment group, whether equipment related to the spare part has a failure probability that exceeds a preselected threshold failure probability, and designate the spare part as a critical spare part if the failure probability exceeds the preset threshold failure probability.

6. The system according to claim 5, wherein the preselected threshold failure probability is a preselected safety standard threshold failure probability.

7. The system according to claim 1, wherein the processor further causes the system to identify any spare part designated as a critical spare part to a supply chain system via the communication interface, the supply chain system configured to procure any spare part designated as a critical spare part for the MODU.

8. A method of identifying critical spare parts for stocking aboard a mobile offshore drilling unit (MODU), comprising:
receiving a list of spare parts from an external or internal system, each spare part being classified in one of several equipment groups;
determining, for a spare part classified in a first equipment group or a second equipment group, (a) whether a loss risk from not stocking the spare part exceeds a loss risk from stocking the spare part, and (b) whether a worst case loss risk from not stocking the spare part exceeds a predefined loss risk threshold;
designating the spare part as a critical spare part if both (a) and (b) are determined to be affirmative;
identifying any spare part designated as a critical spare part to an inventory tracking system; and
tracking any spare part designated as a critical spare part using the inventory tracking system to ensure the spare part is stocked aboard the MODU.

9. The method according to claim 8, wherein (a) is determined by determining whether a loss risk from Scenario 1 plus Scenario 2 exceeds a loss risk from Scenario 3 plus Scenario 4, where Scenario 1 assumes equipment related to the spare part has failed and the spare part is stocked, Scenario 2 assumes equipment related to the spare part has not failed and the spare part is stocked, Scenario 3 assumes equipment related to the spare part has failed and the spare part is not stocked, and Scenario 4 assumes equipment related to the spare part has not failed and the spare part is not stocked.

10. The method according to claim 9, wherein the loss risk from each of Scenario 1, Scenario 2, Scenario 3, and Scenario 4 is determined by multiplying probable objective losses resulting from the equipment related to the spare part failing or not failing, respectively, for each scenario, times a probability of the equipment related to the spare part failing or not failing, respectively, for said scenario.

11. The method according to claim 8, wherein the worst case loss risk in (b) is determined by assuming equipment related to the spare part has failed and the spare part is not stocked, then multiplying probable objective losses resulting from the equipment failing times a probability of the equipment failing.

12. The method according to claim 8, further comprising determining, for a spare part classified in a third equipment group, whether equipment related to the spare part has a failure probability that exceeds a preselected threshold failure probability, and designating the spare part as a critical spare part if the failure probability exceeds the preset threshold failure probability.

13. The method according to claim 5, wherein the preselected threshold failure probability is a preselected safety standard threshold failure probability.

14. The method according to claim 6, further comprising identifying any spare part designated as a critical spare part to a supply chain system, the supply chain system operating to procure any spare part designated as a critical spare part for the MODU.

15. A system for stocking critical spare parts aboard a mobile offshore drilling unit (MODU), comprising:
a subsystem operable to procure spare parts designated as critical spare parts for the MODU;
a subsystem operable to track spare parts designated as critical spare parts to ensure the critical spare parts are stocked aboard the MODU; and
a subsystem operable to identify critical spare parts from a list of spare parts for stocking aboard the MODU by:
receiving the list of spare parts from an external or internal system, each spare part being classified in one of several equipment groups;
determining, for a spare part classified in a first equipment group or a second equipment group, (a) whether a loss risk from not stocking the spare part exceeds a loss risk from stocking the spare part, and (b) whether a worst case loss risk from not stocking the spare part exceeds a predefined loss risk threshold;
designating the spare part as a critical spare part if both (a) and (b) are determined to be affirmative; and
identifying any spare part designated as a critical spare part to the subsystem operable to procure spare parts and the subsystem operable to track spare parts.

16. The system according to claim 15, wherein the subsystem operable to identify critical spare parts determines (a) by determining whether a loss risk from Scenario 1 plus Scenario 2 exceeds a loss risk from Scenario 3 plus Scenario 4, where Scenario 1 assumes equipment related to the spare part has failed and the spare part is stocked, Scenario 2 assumes equipment related to the spare part has not failed and the spare part is stocked, Scenario 3 assumes equipment related to the spare part has failed and the spare part is not stocked, and Scenario 4 assumes equipment related to the spare part has not failed and the spare part is not stocked.

17. The system according to claim 16, wherein the subsystem operable to identify critical spare parts determines the loss risk from each of Scenario 1, Scenario 2, Scenario 3, and Scenario 4 by multiplying probable objective losses resulting from the equipment related to the spare part failing or not failing, respectively, for each scenario, times a probability of the equipment related to the spare part failing or not failing, respectively, for said scenario.

18. The system according to claim 15, wherein the subsystem operable to identify critical spare parts determines the worst case loss risk in (b) by assuming equipment related to the spare part has failed and the spare part is not stocked, then multiplying probable objective losses resulting from the equipment failing times a probability of the equipment failing.

19. The system according to claim 15, wherein the subsystem operable to identify critical spare parts further determines, for a spare part classified in a third equipment group, whether equipment related to the spare part has a failure probability that exceeds a preselected threshold failure probability, and designates the spare part as a critical spare part if the failure probability exceeds the preset threshold failure probability.

20. The system according to claim 19, wherein the preselected threshold failure probability is a preselected safety standard threshold failure probability.
